(19) United States
(12) Patent Application Publication
(10) Pub. No.: US 2026/0186605 A1
(43) Pub. Date: Jul. 2, 2026

(54) ULTRSONIC TRANSDUCER AND MANUFACTURING METHOD THEREOF, DISPLAY PANEL AND DISPLAY DEVICE

(71) Applicants: Beijing BOE Technology Development Co., Ltd., Beijing (CN); BOE Technology Group Co., Ltd., Beijing (CN)

(72) Inventors: Wenqu LIU, Beijing (CN); Tengfei LIU, Beijing (CN); Dongfei HOU, Beijing (CN); Feng ZHANG, Beijing (CN)

(21) Appl. No.: 18/857,794

(22) PCT Filed: Sep. 25, 2023
(86) PCT No.: PCT/CN2023/121207

§ 371 Date: Oct. 17, 2024

(51) Int. Cl. G06F 3/043

(52) U.S. Cl. CPC G06F 3/0436

(57) ABSTRACT

The disclosure provides an ultrasonic transducer and manufacturing method thereof, display panel and device. The ultrasonic transducer includes: a drive backboard, first and second conductive layers, a first inorganic layer, and a first inorganic filling portion. The first conductive layer is on the drive backboard. The first conductive layer includes a first electrode. The first inorganic layer is on the side of the first conductive layer. There are a vibrating cavity and an etching cavity between the first inorganic layer and the first conductive layer. The first inorganic layer has an etching through hole penetrating the first inorganic layer. The etching cavity is connected to the vibrating cavity and the etching through hole. The second conductive layer is on the side of the first inorganic layer. The second conductive layer includes a second electrode. The first inorganic filling portion is in the etching cavity and the etching through hole.

### CROSS-REFERENCE TO RELATED APPLICATIONS

This application is a national phase entry under 35 U.S.C § 371 of International Application No. PCT/CN2023/121207, filed on Sep. 25, 2023, which is hereby incorporated by reference in its entirety.

### TECHNICAL FIELD

The present disclosure relates to the field of sensing technology, in particular to an ultrasonic transducer and manufacturing method thereof, a display panel and a display device.

### BACKGROUND

Fingerprint recognition technology is widely used in mobile terminals such as mobile phones and tablets, as well as in security protection fields such as access control systems and safes. At present, the realization mode of fingerprint collection in fingerprint recognition technology mainly includes optical, capacitive and ultrasonic imaging. The fingerprint collection of ultrasonic fingerprint recognition technology has 3D characteristics, and the user's finger is not necessary to touch the fingerprint collection device, which can improve the security of identification and the user's use experience.

### SUMMARY

The first aspect of the present disclosure provides an ultrasonic transducer including:
a drive backboard;
a first conductive layer on the drive backboard; the first conductive layer includes a first electrode, and the first electrode is electrically connected with the drive backboard;
a first inorganic layer on a side away from the drive backboard, of the first conductive layer; wherein a vibrating cavity and an etching cavity are provided between the first inorganic layer and the first conductive layer; the first inorganic layer includes an etching through hole penetrating the first inorganic layer in a direction perpendicular to the drive backboard; the etching cavity is connected with the vibrating cavity and the etching through hole respectively to form an etching channel;
a second conductive layer on a side away from the drive backboard, of the first inorganic layer; the second conductive layer includes a second electrode;
a first inorganic filling portion in the etching cavity and the etching through hole to plug the etching through hole; a material of the first inorganic filling portion is an inorganic material.

In the ultrasonic transducer provided by the present disclosure, a thickness of the second conductive layer is greater than or equal to a depth of the etching cavity; the first inorganic filling portion is in the second conductive layer.

In the ultrasonic transducer provided by the present disclosure, the ultrasonic transducer further includes:
a first planarization layer on a side away from the drive backboard, of the second conductive layer; an orthographic projection of the first planarization layer on the drive backboard does not overlap with an orthographic projection of the vibrating cavity on the drive backboard;
a second inorganic layer on a side away from the drive backboard, of the first planarization layer, and covering the first planarization layer and the second conductive layer.

In the ultrasonic transducer provided by the present disclosure, a height of the first inorganic layer in a region overlapping with the vibrating cavity is greater than a height of other regions of the first inorganic layer;
a height of the first planarization layer is less than or equal to the height of the first inorganic layer in the region overlapping with the vibration cavity, so as to expose a surface of the first inorganic layer in the region overlapping with the vibrating cavity.

In the ultrasonic transducer provided by the present disclosure, a thickness of the second conductive layer is less than a depth of the vibrating cavity;
the ultrasonic transducer further includes:
a third inorganic layer on a side away from the drive backboard, of the first inorganic layer; the first inorganic filling portion is in the third inorganic layer.

In the ultrasonic transducer provided by the present disclosure, the third inorganic layer is between the second conductive layer and the first inorganic layer; a thickness of the third inorganic layer is greater than or equal to a depth of the etching cavity.

In the ultrasonic transducer provided by the present disclosure, the thickness of the third inorganic layer is less than a sum of the depth of the etching cavity and a thickness of the first inorganic layer; the first inorganic filling portion is not completely filled with the etching through hole so as to form a pit;
the second conductive layer further includes a second inorganic filling portion; the second filling portion is in the pit.

In the ultrasonic transducer provided by the present disclosure, an orthotropic projection of the second conductive layer on the drive backboard does not overlap with an orthotropic projection of the etching through hole on the drive backboard.

In the ultrasonic transducer provided by the present disclosure, the ultrasonic transducer further includes:
a fourth inorganic layer on a side away from the third inorganic layer, of the second conductive layer and covering the second conductive layer.

In the ultrasonic transducer provided by the present disclosure, the third inorganic layer is on a side away from the first inorganic layer, of the second conductive layer and covers the second conductive layer.

In the ultrasonic transducer provided by the present disclosure, the second conductive layer further includes a second inorganic filling portion; the second inorganic filling portion is in the etching cavity; the first inorganic filling portion is on a side away from the drive backboard, of the second inorganic filling portion; a thickness of the third inorganic layer is greater than or equal to a difference between the depth of the vibrating cavity and the thickness of the second conductive layer.

In the ultrasonic transducer provided by the present disclosure, an orthographic projection of the second conductive layer on the drive backboard does not overlap with an orthographic projection of the etching through hole on the drive backboard; a thickness of the third inorganic layer is greater than or equal to the depth of the etching cavity.

In the ultrasonic transducer provided by the present disclosure, the ultrasonic transducer further includes:
a second planarization layer on a side away from the drive backboard of the third inorganic layer;
a height of the third inorganic layer in a region overlapping with the vibrating cavity is greater than a height of other regions of the third inorganic layer;
a height of the second planarization layer is less than or equal to the height of the third inorganic layer in the region overlapping with the vibrating cavity, so as to expose a surface of the third inorganic layer in the region overlapping with the vibrating cavity.

In the ultrasonic transducer provided by the present disclosure, the ultrasonic transducer further includes:
a buffer layer between the first conductive layer and the first inorganic layer; the vibrating cavity and the etching cavity are between the first inorganic layer and the buffer layer.

The second aspect of the present disclosure provides a display panel including the ultrasonic transducer of any one of above descriptions.

The third aspect of the present disclosure provides a display device including the display panel of above description.

The fourth aspect of the present disclosure provides a manufacturing method for ultrasonic transducer including:
forming a first conductive layer on a side of a drive backboard; wherein the first conductive layer includes a first electrode, and the first electrode is electrically connected with the drive backboard;
preparing a sacrificial layer on a side away from the drive backboard, of the first conductive layer, etching the sacrificial layer to form a vibrating cavity pattern and an etching cavity pattern; the etching cavity pattern is connected with the vibrating cavity pattern;
preparing a first inorganic layer on a side away from the first conductive layer, of the sacrificial layer, etching the first inorganic layer to form an etched through hole that penetrates the first inorganic layer in a direction perpendicular to the drive backboard; wherein the etching through hole exposes the etching cavity pattern;
etching the sacrificial layer by a wet etching, so that an etching solution etches the etching cavity pattern and the vibrating cavity pattern successively through the etching through hole to form a vibrating cavity and an etching cavity;
preparing a second conductive layer on a side away from the drive backboard, of the first inorganic layer; wherein the second conductive layer includes a second electrode;
preparing a first inorganic filling portion by a thin film deposition process; wherein the first inorganic filling portion is in the etching cavity and the etching through hole to plug the etching through hole.

### BRIEF DESCRIPTION OF FIGURES

In order to illustrate more clearly the technical solutions of the embodiments of the present disclosure, the drawings that need to be used in the embodiments of the present disclosure will be briefly described below, and it is obvious that the drawings introduced below are only some embodiments of the present disclosure, and for those skilled in the art, other drawings can also be obtained according to these drawings without creative labor.

FIG. 1A is a top view of a structure of a ultrasonic transducer provided by an embodiment of the present disclosure;

FIG. 1B is the first schematic diagram of the cross-sectional structure of the ultrasonic transducer provided by an present embodiment;

FIG. 1C is the second schematic diagram of the cross-sectional structure of the ultrasonic transducer provided by an embodiment of the present disclosure;

FIG. 1D is the third schematic diagram of the cross-sectional structure of the ultrasonic transducer provided by an embodiment of the present disclosure;

FIG. 2A is a schematic diagram of the microstructure of an etching through hole encapsulated by organic materials;

FIG. 2B is a schematic diagram of the microstructure of an etching through hole encapsulated by inorganic materials;

FIG. 3A is the fourth schematic diagram of the cross-sectional structure of the ultrasonic transducer provided by an embodiment of the present disclosure;

FIG. 3B is the fifth schematic diagram of the cross-sectional structure of the ultrasonic transducer provided by an embodiment of the present disclosure;

FIG. 4A is the sixth schematic diagram of the cross-sectional structure of the ultrasonic transducer provided by an embodiment of the present disclosure;

FIG. 4B is the seventh schematic diagram of the cross-sectional structure of the ultrasonic transducer provided by an present embodiment;

FIG. 4C is the eighth of the cross-sectional structure schematic diagram of the ultrasonic transducer provided by an embodiment of the present disclosure;

FIG. 4D is the ninth schematic diagram of the cross-sectional structure of the ultrasonic transducer provided by an embodiment of the present disclosure;

FIG. 4E is the tenth of the cross-sectional structure schematic diagram of the ultrasonic transducer provided by an embodiment of the present disclosure;

FIG. 4F is the eleventh schematic diagram of the cross-sectional structure of the ultrasonic transducer provided by an embodiment of the present disclosure;

FIG. 4G is the twelfth of the cross-sectional structure schematic diagram of the ultrasonic transducer provided by an present embodiment;

FIG. 4H is the thirteenth schematic diagram of the cross-sectional structure of the ultrasonic transducer provided by an present embodiment;

FIG. 5 is a schematic diagram of the cross-sectional structure of a display panel provided by an embodiment of the present disclosure;

FIG. 6 is a flow chart of the manufacturing method of the ultrasonic transducer provided by an embodiment of the present disclosure.

### DETAILED DESCRIPTION

In order to make the above-mentioned purpose, features and advantages of the present disclosure more obvious and easy to understand, the present disclosure will be further explained below in conjunction with the accompanying drawings and embodiments. However, example embodiments can be implemented in a variety of forms and should not be construed as confined to those described herein. On the contrary, the provision of these embodiments makes the present disclosure more comprehensive and complete, and comprehensively communicates the idea of an example embodiment to those skilled in the art. The same drawing marks in the diagram indicate the same or similar structures, and repeated descriptions of them will be omitted. The words used in this disclosure to express the position and direction are illustrated with the accompanying drawings as an example, but they may be changed as needed, and all changes made are covered by the scope of protection of this disclosure. The drawings disclosed in this document are for illustrative purposes only and do not represent true proportions.

Fingerprint recognition technology is widely used in mobile terminals such as mobile phones and tablets, as well as in security protection fields such as access control systems and safes. At present, the realization mode of fingerprint collection in fingerprint recognition technology mainly includes optical, capacitive and ultrasonic imaging. The fingerprint collection of ultrasonic fingerprint recognition technology has 3D characteristics, and the user's finger is not necessary to touch the fingerprint collection device, which can improve the security of identification and the user's use experience.

Ultrasonic fingerprint recognition technology often uses Piezoelectric Micromachined ultrasonic transducers (PMUT) or Capacitive Micromachined Ultrasonic transducers (CMUT) as ultrasonic transmitting and receiving devices. Compared with traditional PMUT, the CMUT has a larger signal bandwidth and penetration ability, and has attracted great attention in the field of ultrasound imaging. At present, the CMUT still has the problems of difficult to make a vibrating cavity and low yield.

In view of this, the first aspect of the embodiment of the present disclosure provides an ultrasonic transducer for improving product yield.

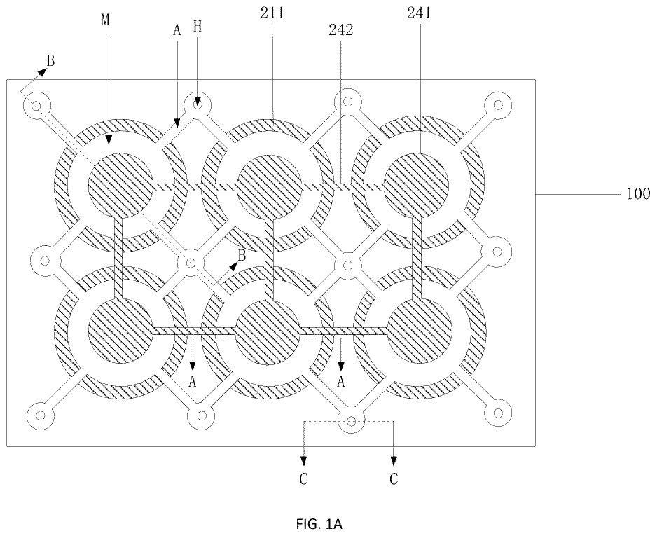

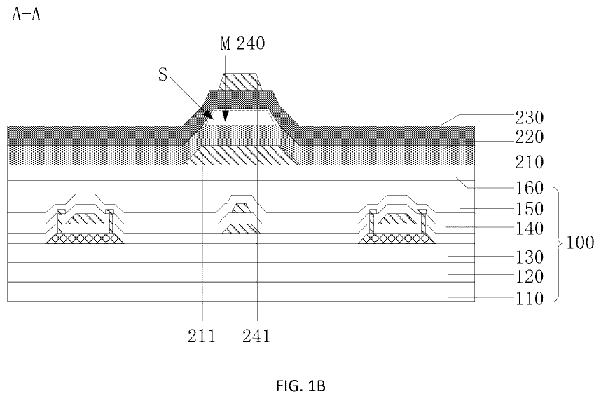

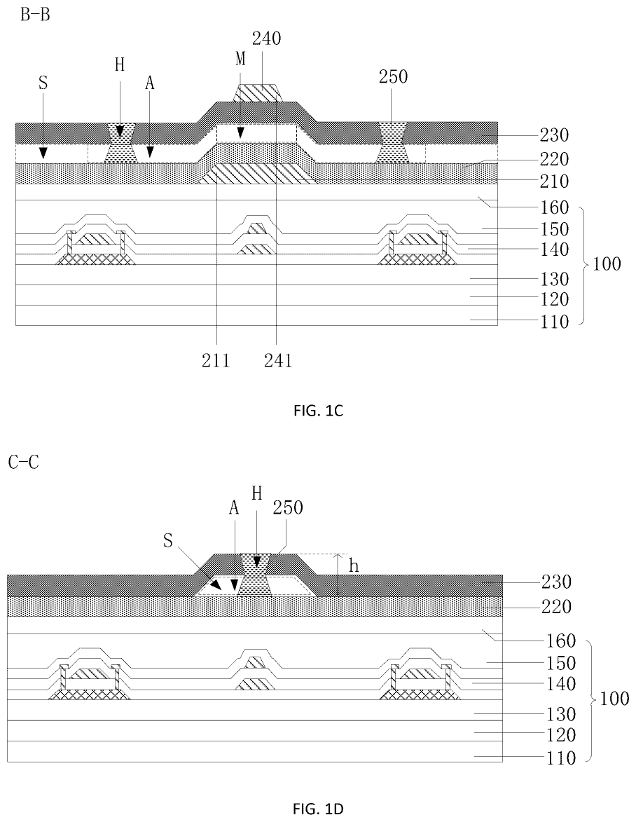

FIG. 1A is a top view of the ultrasonic transducer provided by an embodiment of the present disclosure. FIG. 1B is the first schematic diagram of the cross-sectional structure of the ultrasonic transducer provided by an embodiment of the present embodiment. FIG. 1C is the second schematic diagram of the cross-sectional structure of the ultrasonic transducer provided by an embodiment of the present disclosure. FIG. 1D is the third schematic diagram of the cross-sectional structure of the ultrasonic transducer provided by an embodiment of the present disclosure.

In the embodiment of the present disclosure, as shown in FIG. 1A to FIG. 1D. FIG. 1A is a top view of the local area of the ultrasonic transducer. FIG. 1B is a schematic diagram of the cross-sectional structure along the cross-sectional line A-A in FIG. 1A. FIG. 1C is a schematic diagram of the cross-sectional structure along the cross-sectional line B-B in FIG. 1A. FIG. 1D is a schematic diagram of the cross-sectional structure along the cross-sectional line C-C in FIG. 1A. The ultrasonic transducer includes a drive backboard 100, a first conductive layer 210, a first inorganic layer 230, a second conductive layer 240 and a first inorganic filling portion 250.

The drive backboard 100 is located at the bottom of the ultrasonic transducer. The drive backboard 100 includes a drive circuit having a plurality of Thin Film Transistors (TFTs), capacitors, and resistors. In the specific implementation, the drive backboard can be made by glass-based process. Taking the Low-Temperature Poly-Si (referred to as LTPS) TFT drive backboard as an example, and the manufacturing process mainly includes the following processes.
1. Preparing a flexible layer 120 and a barrier layer 130 on a glass substrate 110 to form a flexible substrate. In specific implementation, the flexible layer 120 and the barrier layer 130 can be a single-layer structure or a multilayer structure. When the multilayer structure is adopted, a plurality of flexible layers 120 and a plurality of barrier layers 130 can be alternately arranged, and no limitation is made herein. The material of the flexible layer 120 can be polyimide (referred to as PI), and the material of the barrier layer 130 can be made of inorganic materials such as silicon oxide, silicon nitride, silicon nitride, etc., which are not limited here.
2. Depositing the low-temperature polysilicon on the surface of the flexible substrate manufactured on the glass substrate 110, and etching to make an active layer for forming a TFT conductive channel.
3. Preparing a gate insulator (GI) on a side away from the glass substrate 110, of the active layer. The material of the gate insulator can be silicon oxide, silicon nitride, silicon nitride and other insulating materials, which are not limited here.
4. Preparing a gate metal layer on a side away from the active layer, of the gate insulator. The gate metal layer includes the gate of the TFT. The gate metal layer can also include the lower electrode of the capacitor, which is not limited here. The material of the gate metal layer can be conductive materials such as metal, which is not limited here.
5. Preparing a first Interlayer Insulating Layer (ILD) 140 on a side away from the gate insulator, of the gate metal layer, and after being exposed by a mask, etching the first interlayer insulating layer 140 and the gate insulator to make the first opening that penetrates the first interlayer insulating layer 140 and the gate insulator at the same time. The first opening exposes the source region and the drain region of the active layer. The material of the first interlayer insulating layer 140 may be insulating materials such as silicon oxide, silicon nitride, silicon nitride, etc., which are not limited herein.
6. Preparing the first source-drain metal layer (SD1) on a side away from the gate metal layer, of the first interlayer insulating layer 140. The first source-drain metal layer includes a source and a drain of the TFT. The source and drain of the TFT are filled in the first opening formed by the first interlayer insulating layer 140 and are electrically connected with the source region and the drain region of the active layer respectively. The first source-drain metal layer can also include the upper electrode of the capacitor, wirings configured to connect each TFT, and wirings with other functions, which are not limited here. The material of the first source-drain metal layer can be conductive materials such as metal, and there is no restriction here.
7. Preparing a second interlayer insulating layer on a side away from the first layer insulating layer 140, of the first source-drain metal layer, and etching the second layer insulating layer to make a second opening for exposing the source or drain of parts of TFTs (not shown in drawings). The material of the second interlayer insulating layer can be silicon oxide, silicon nitride, silicon nitride and other insulating materials, which is not limited here.
8. Preparing a second source-drain metal layer on a side away from the first source-drain metal layer, of the second interlayer insulating layer, and the second source-drain metal layer is at least partially filled in the second opening, and is electrically connected with the source or drain exposed by the second opening, so as to lead the source or drain to the surface of the second interlayer insulating layer to facilitate subsequent connection (not shown in the drawings). The second source-drain metal layer can also include wirings with other functions, which are not limited here.
9. Preparing a third planarization layer (Plane, referred to as PLN) 150 on a side away from the second interlayer insulating layer, of the second source-drain metal layer. The third planarization layer 150 can be made of organic materials such as resin, which needs to be aged in a heating furnace to solidify the organic materials. The third planarization layer 150 is formed by an etching process with a third opening exposing the second source-drain metal layer (not shown in the drawings).
10. Preparing a passivation layer (PVX) 160 on a side away from the second source-drain metal layer, of the third planarization layer 150, and preparing a fourth opening penetrating through the passivation layer 160 on the passivation layer 160 through the etching process (not shown in the drawings). The orthographic projection of the fourth opening on the glass substrate 110 coincides with the orthographic projection of the third opening on the glass substrate 110, so that the fourth opening is communicated with the third opening, and the first electrode is electrically connected with the drive backboard 100 subsequently.

The above process is illustrated by the manufacturing process of a top-gate LTPS TFT drive backboard. In some embodiments, the TFT in the drive backboard 100 may also be a bottom gate type or a double gate type structure, and no limitation is made herein. In some embodiments, the drive backboard 100 can also be an oxide TFT drive backboard or an LTPO drive backboard, etc., and is not limited herein. In the specific implementation, the drive backboard can be manufactured according to the specific structure of the drive backboard and the manufacturing method of the drive backboard in the related technology, which will not be repeated here. In some embodiments, after the drive backboard 100 is manufactured or after the ultrasonic transducer is manufactured, the glass substrate 110 can also be removed and the flexible substrate is retained to realize the flexible device, and no limitation is made herein.

The first conductive layer 210 is positioned above the drive backboard 100, and specifically the first conductive layer 210 is on a side away from the third planarization layer 150, of the passivation layer 160. The first conductive layer 210 includes a first electrode 211, and the first electrode 211 is electrically connected with the drive backboard 100 through the fourth opening and the third opening. The first conductive layer 210 may be made of metallic conductive material or non-metallic conductive material, which is not limited herein. Taking the material of the first conductive layer 210 being Mo as an example, the thickness of the first conductive layer is usually set to 3000 Å to 5000 Å, and the specific can be set to 4000 Å, which is not limited here.

The first inorganic layer 230 is on a side away from the drive backboard 100, of the first conductive layer 210. There is a vibrating cavity M and an etching cavity A between the first inorganic layer 230 and the first conductive layer 210. The first inorganic layer 230 has an etching through hole H that penetrates the first inorganic layer 230 in a direction perpendicular to the drive backboard 100. The first inorganic layer 230 described in the embodiment of the present disclosure has an etching through hole H penetrating the first inorganic layer 230 in a direction perpendicular to the drive backboard 100, specifically the etching through hole H is completely perpendicular to the drive backboard 100, or the etching through hole H is at an acute angle of a certain size to a direction perpendicular to the drive backboard 100, and the size of the acute angle is not limited herein. The etching cavity A is connected with the vibrating cavity M and the etching through hole H respectively to form a etching channel. In the specific implementation, the first inorganic layer 230 may be made from low-temperature polysilicon, silicon nitride (SiN) or silicon oxide (SiO2) as a single-layer or multi-layer structure, and no limitation is made herein. Taking the first inorganic layer of SiN as an example, the thickness of the first inorganic layer 230 can usually be set to 1500 Å to 2500 Å, and specifically it can be set to 2000 Å, which is not limited here.

The second conductive layer 240 is on a side away from the drive backboard 100, of the first inorganic layer 230. The second conductive layer 240 includes a second electrode 241. The second conductive layer 240 may be made from metallic conductive material or non-metallic conductive material, which is not limited herein.

The first inorganic filling part 250 is in the etching cavity A and the etching through hole H to plug the etching through hole H, prevent water and oxygen from the etching through hole H from invading to the inside of the ultrasonic transducer, and improve the service life of the ultrasonic transducer. In specific implementation, the first inorganic filling part 250 can be made from inorganic materials such as silicon nitride, silicon oxide, silicon nitride, etc., by a thin film deposition process.

The vibrating cavity M corresponds to the first electrode 211 and the second electrode 241, and the vibrating cavity M is positioned between the corresponding first electrode 211 and the corresponding second electrode 241 to form an energy transducer unit. The ultrasonic transducer may include at least one energy transducer unit, which is not limited herein. In the emission phase, the drive backboard 100 simultaneously applies a DC signal and an AC signal to the first electrode 211 and the second electrode 241 so that the first inorganic layer 230 above the vibrating cavity M vibrates and emits ultrasonic waves with the change of electric field. In the receiving phase, only a DC signal is applied to the first electrode 211 and the second electrode 241 to keep the first inorganic layer 230 balanced and the ultrasonic wave is received. As shown in FIG. 1A, the orthographic projection of the second electrode 241 on the drive backboard 100 can be arranged to be within the orthographic projection of the corresponding vibrating cavity M on the drive backboard 100, and the orthographic projection of the vibrating cavity M on the drive backboard 100 is within the orthographic projection of the corresponding first electrode 211 on the drive backboard 100, so as to improve the sensitivity of the ultrasonic transducer unit. In the specific embodiment, the area of the orthographic projection of the second electrode 241 on the drive backboard 100 can be arranged to be 0.5 times to 0.7 times of the area of the orthographic projection of the corresponding vibrating cavity M on the drive backboard 100, and the spacing between the edge of the orthographic projection of the vibrating cavity M on the drive backboard 100 and the edge of the orthographic projection of the corresponding first electrode 211 on the drive backboard 100 is 1.5 μm to 2.5 μm, thereby obtaining the better sensitivity. Specifically, the area of the orthographic projection of the second electrode 241 on the drive backboard 100 can be arranged to be 0.6 times the area of the orthographic projection of the corresponding vibrating cavity M on the drive backboard 100, and the spacing between the edge of the orthographic projection of the vibrating cavity M on the drive backboard 100 and the edge of the orthographic projection of the corresponding first electrode 211 on the drive backboard 100 is 2 am, and no limitation is made herein.

In the embodiment of the disclosure, the ultrasonic transducer unit may be CMUT and is not limited herein.

In the specific embodiment, the above-mentioned structure of the ultrasonic transducer provided in the embodiment of the present disclosure may by specifically manufactured by the following steps.
1. Forming a first conductive layer 210 on the drive backboard 100, and then forming a buffer layer 220 on a side away from the drive backboard 100, of the first conductive layer 210 for insulating the first conductive layer 210.
2. Forming a sacrificial layer S on a side away from the first conductive layer 210, of the buffer layer 220. In specific implementation, the sacrificial layer S can be deposited on the surface of the buffer layer 220 with metal materials such as Mo, Cu, Al; then etching the sacrificial layer S through the etching process to form a vibrating cavity pattern and an etching cavity pattern; the etching cavity pattern is connected with the vibrating cavity pattern, and the etching cavity A and the vibrating cavity M can be formed by etching the etching cavity pattern and the vibrating cavity pattern. Taking the material of sacrificial layer S being Mo as an example, the thickness of sacrificial layer S can usually be 1000 Å to 4000 Å. Specifically, the thickness of the sacrificial layer S can be 3000 Å, so that the depth of the etching cavity A and the vibrating cavity M obtained after etching the sacrificial layer S is 3000 Å.
3. Preparing a first inorganic layer 230 on a side away from the buffer layer 220, of the sacrificial layer S, and forming an etching through hole H by an etching process in the direction perpendicular to the drive backboard 100; the etching through hole H penetrates the first inorganic layer 230 and exposes the etching cavity pattern.
4. Etching the sacrificial layer S by wet etching, the etching liquid flows from the etching through hole H, first contacts with the etching cavity pattern, and etches the etching cavity pattern, after etching the etching cavity pattern, the etching solution further contacts with the vibration cavity pattern, and begins to etch the vibration cavity pattern until the sacrificial layer S between the first inorganic layer 230 and the buffer layer 220 is completely etched off, forming a vibrating cavity M and an etching cavity A.
5. Preparing a second conductive layer 240 on a side away from the drive backboard 100, of the first inorganic layer 230, etching the second conductive layer 240 to form a second electrode 241.
6. Depositing the first inorganic filling portion 250 in the etching cavity A and the etching through hole H through the thin film deposition process, so that the first inorganic filling portion 250 is filled in the etching through hole H to plug the etching through hole H.

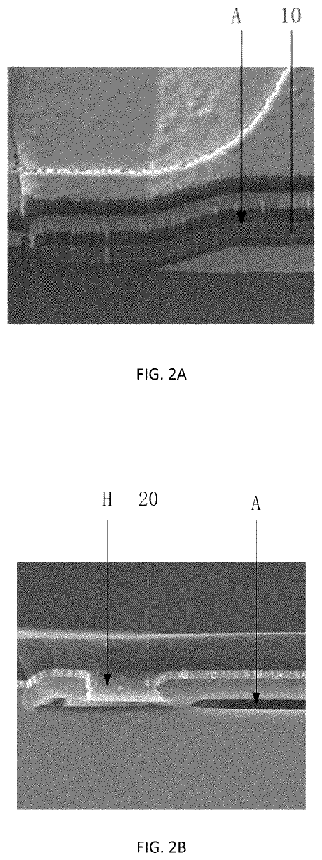

FIG. 2A is a diagram of the microstructure of the etching through hole encapsulated by organic materials. FIG. 2B is a diagram of the microstructure of the etching through hole encapsulated by inorganic materials.

In the manufacturing process of the ultrasonic transducer provided in the embodiment of the present disclosure, after forming a vibrating cavity M and an etching cavity A by wet etching the sacrificial layer S, the etching through hole H is encapsulated by a thin film deposition process, and the inorganic material no longer flows after attaching to the substrate surface, and the film-forming process has good directionality, and the inorganic material can be avoided from diffusing into the vibrating cavity M along the extension direction of the etching cavity A and causing blockage to the vibrating cavity M. In some technical routes, organic materials are used to directly fill the etching cavity M and the etching through hole H, the organic material has a certain fluidity, when the organic material is used to encapsulate the etching through hole H, the organic material flows into the vibrating cavity M along the extension direction of the etching cavity A, which is easy to cause the blockage of the vibrating cavity M, resulting in product defects. The product yield can be greatly improved by using inorganic materials to encapsulate the etching through hole H compared with the use of organic materials to encapsulate the etching through hole H. As shown in FIG. 2A, when the etching through holes are encapsulated with organic materials, the organic materials 10 flow along the extension direction of the etching cavity A to completely fill the etching cavity A, and the risk of blocking the vibrating cavity is greater. As shown in FIG. 2B, when the etched through hole H is encapsulated with inorganic materials, the inorganic materials 20 (in the figure, taking the second conductive layer deposited in the etching cavity A as an example) are only deposited directly below the etched through hole H and in the local area adjacent to the etched through hole H, and do not diffuse to a large extent along the extension direction of the etching cavity A to block the vibration cavity.

In addition, as shown in FIG. 1D, in the ultrasonic transducer provided in the embodiment of the present disclosure, the etching through hole H is directly formed on the first inorganic layer 230, and when the etching through hole H is encapsulated, the etching through hole H and the etching cavity A directly opposite below the etching through hole H are completely filled in the direction perpendicular to the drive backboard 100, and the thickness h of the encapsulation layer that needs to be deposited is only the sum of the depth of the etching cavity A and the thickness of the first inorganic layer 230. Taking the depth of the etching cavity A is 3000 Å, the thickness of the first inorganic layer 230 is 2000 Å as an example, in order to completely fill the etching cavity A directly opposite the etching through hole H and the etching through hole H, only a film layer with a thickness of 5000 Å needs to be deposited, and the thickness of the required encapsulation layer is small, which is conducive to reducing the difficulty of preparing the encapsulation layer.

As shown in FIG. 1A, the second electrodes 241 of the plurality of transducer units of the ultrasonic transducer are connected with each other through the connecting wire 242 arranged on a layer same as a layer where the second electrodes 241 are. The sacrificial layer S is made from Mo, and Mo has good etching performance, so that the corner positions of the layers formed on sides away from the drive backboard 100, of the etching cavity pattern and the vibrating cavity pattern are more smoothly transitioned by adjusting the inclination angle of the sidewall of the etching cavity pattern and the inclination angle of the side wall of the vibrating cavity pattern, it is beneficial to avoid the connecting wire 242 from breaking at the corner positions of the layers, and improve the product yield.

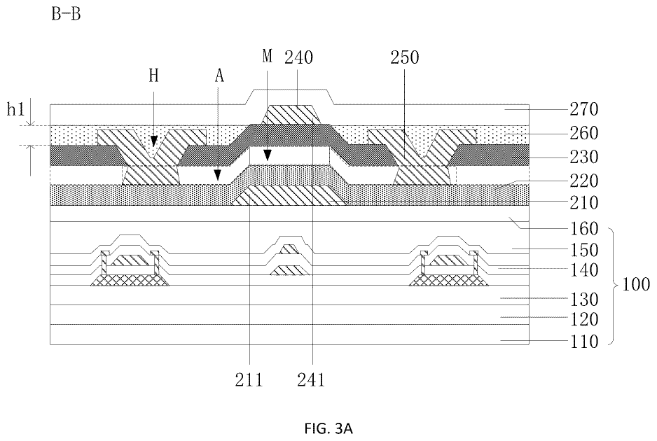

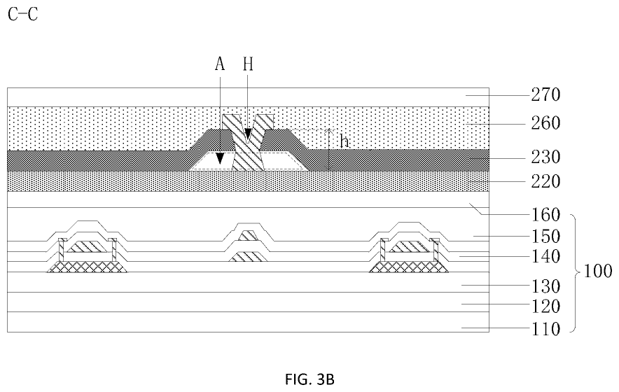

FIG. 3A is the fourth schematic diagram of the cross-sectional structure of the ultrasonic transducer provided by an embodiment of the present disclosure. FIG. 3B is the fifth schematic diagram of the cross-sectional structure of the ultrasonic transducer provided by an embodiment of the present disclosure.

In some embodiments, as shown in FIG. 3A and FIG. 3B, FIG. 3A is a schematic diagram of the cross-sectional structure of FIG. 1A along the cross-sectional line B-B, FIG. 3B is a schematic diagram of the cross-sectional structure of FIG. 1A along the cross-sectional line C-C, the thickness of the second conductive layer 240 is greater than or equal to the depth of the etching cavity A, and the first inorganic filling portion 250 is in the second conductive layer 240. In the specific implementation, when preparing the second conductive layer 240, inorganic conductive materials such as metals can be deposited on a side away from the drive backboard 100, of the first inorganic layer 230 through a thin film deposition process. In the deposition process, a part of the inorganic conductive materials are formed in the etching cavity A through the etching through hole H. When the thickness of the second conductive layer 240 is equal to the depth of the etching cavity A, the inorganic conductive materials deposited in the etching cavity A can just block the etching through hole H, and some inorganic conductive materials are attached to the side wall of the etching through hole H. The inorganic conductive materials attached to the side wall of the etching through hole H form a continuous, uninterrupted film layer with the inorganic conductive materials deposited in the etching cavity A, to form the first inorganic filling portion 250, and complete the preliminary encapsulation of the etching through hole. When the thickness of the second conductive layer 240 is greater than the depth of the etching cavity A, more inorganic conductive materials can be deposited in the etching through hole H to improve the encapsulation performance. After depositing the inorganic conductive materials of the second conductive layer 240, the second conductive layer 240 is etched to form a second electrode 241 and a first inorganic filler 250 spaced apart.

As shown in FIG. 3A and FIG. 3B, the ultrasonic transducer also includes a first planarization layer 260 and a second inorganic layer 270. The first planarization layer 260 is on a side away from the drive backboard 100, of the second conductive layer 240, which can further improve the encapsulation performance for the etching through hole H. The first planarization layer 260 is also used for forming a relatively flat surface, which is convenient for the manufacture of the subsequent layer, and the relatively flat surface is conducive to improving the directionality of emitting ultrasonic waves and the sensitivity of receiving ultrasonic waves. The second inorganic layer 270 is on a side away from the drive backboard 100, of the first planarization layer 260, and the second inorganic layer 270 covers the first planarization layer 260 and the second conductive layer 240 to play a further protective role. In the specific embodiment, the orthographic projection of the first planarization layer 260 on the drive backboard 100 does not overlap with the orthographic projection of the vibrating cavity M on the drive backboard 100, so that the first planarization layer 260 can be avoided from increasing the thickness of the vibrating film (including the first inorganic layer 230 and the second inorganic layer 270) located above the vibrating cavity M. The collapse voltage of the vibrating film is calculated as follows:

$${V}_{col} = 0.82 \sqrt{\frac{128 ( {Y}_{o} + T ) {t}_{m}^{3} {t}_{g}^{3}}{27 {ε}_{o} ( 1 - {σ}^{2} ) {a}^{4}}} ;$$

V_{col} is the collapse voltage, tₘ is the thickness of the vibrating film, t_{g} is the depth of the vibrating cavity, a is the radius of the vibrating cavity, Y₀ the Young's modulus of the vibrating film, ε₀ is the dielectric constant of the vibrating film, T is the residual stress of the vibrating film, and a is the Poisson's ratio of the vibrating film. According to the calculation formula of the collapse voltage of the vibrating film, the magnitude of the collapse voltage V_{col} of the vibrating film is related to the thickness of the vibrating film, the less the thickness tₘ of the vibrating film is, the lower the collapse voltage V_{col} is. When the driving voltage applied to the vibrating film is greater than the collapse voltage, the vibrating film will be adsorbed to the bottom of the vibrating cavity and collapse. Normally, the driving voltage applied by the ultrasonic transducer is less than 90% of the collapse voltage. According to the above formula, it can be seen that the less the thickness tₘ of the vibrating film, the lower the collapse voltage V_{col} is, and the lower the required driving voltage is, which is conducive to reducing the energy consumption of the ultrasonic transducer.

In some embodiments, as shown in FIG. 3A, the height of the first inorganic layer 230 in a region overlapping with the vibrating cavity M is greater than the height of the other regions of the first inorganic layer 230, and the height difference between the height of the first inorganic layer 230 in the region overlapping with the vibrating cavity M and the height of the other regions of the first inorganic layer 230 h1 is about the thickness of the first electrode 211. In the specific embodiment, the height of the first planarization layer 260 is less than or equal to the height of the first inorganic layer 230 in the region overlapping with the vibrating cavity M, so as to expose the surface of the first inorganic layer 230 in the region overlapping with the vibrating cavity M, so as to avoid increasing the thickness of the vibrating film after the first planarization layer 260 covers the surface. The first planarization layer 260 can be made from organic materials such as resin by coating, inkjet printing, etc., and the second inorganic layer 270 can be made from inorganic materials such as silicon nitride, silicon nitride, silicon oxide, silicon oxide, etc., by the thin film deposition, and is not limited herein. The second inorganic layer 270 covers the first electrode 241 that is not covered by the first planarization layer 260 to protect the first electrode 241.

In the specific implementation, when the depth of the vibrating cavity M is set to 3000 Å, the thickness of the second conductive layer 240 needs to be set to be greater than or equal to 3000 Å, so that the first inorganic filling portion 250 in the second conductive layer 240 at least just plugs the etching through hole H. In specific implementation, the thickness of the second conductive layer 240 can be set to 4000 Å. When the thickness of the first inorganic layer 230 is 2000 Å, the thickness of the second inorganic layer 270 can be set to 1000 Å to 4000 Å to ensure that the second inorganic layer 270 completely covers the part of the second conductive layer 240 that is not covered by the first planarization layer 260 (for example, the first electrode 241), and at the same time ensure that the thickness of the vibrating film formed by the first inorganic layer 230 and the second inorganic layer 270 is less than 6000 Å, so as to help reduce power consumption and improve the sensitivity of the ultrasonic transducer.

In the embodiments shown in FIG. 3A and FIG. 3B, the second conductive layer 240 is directly used for plugging the etching through hole, and the encapsulation performance for the through hole is increased through the first planarization layer 260, and then on a side away from the drive backboard 100, of the first planarization layer 260, a second inorganic layer 270 is used for covering the part of the second conductive layer 240 that is not covered by the first planarization layer 260, and the thickness of the vibrating film is only the sum of the thickness of the first inorganic layer 230 and the thickness of the second inorganic layer 270, and the thickness of the vibrating film can be effectively controlled, to reduce the power consumption of ultrasonic transducers.

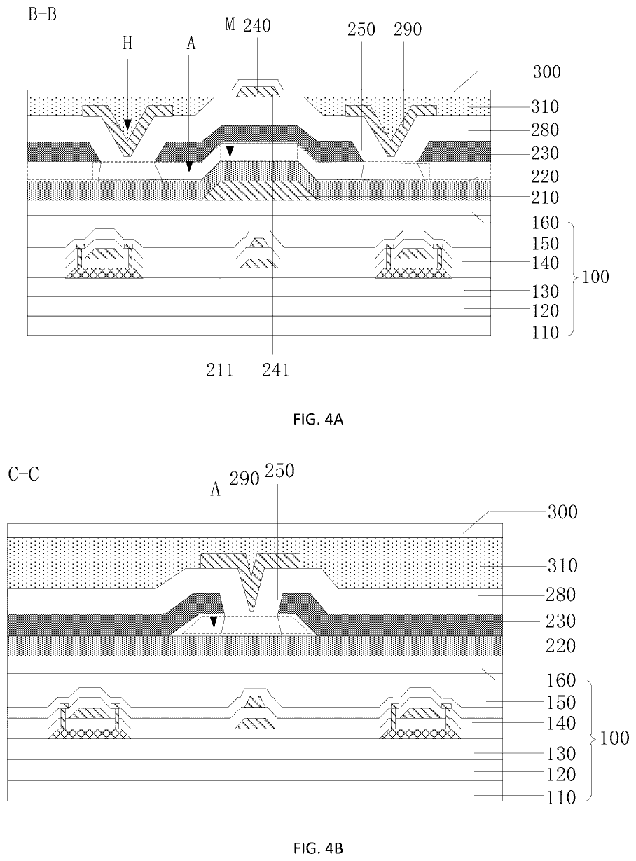

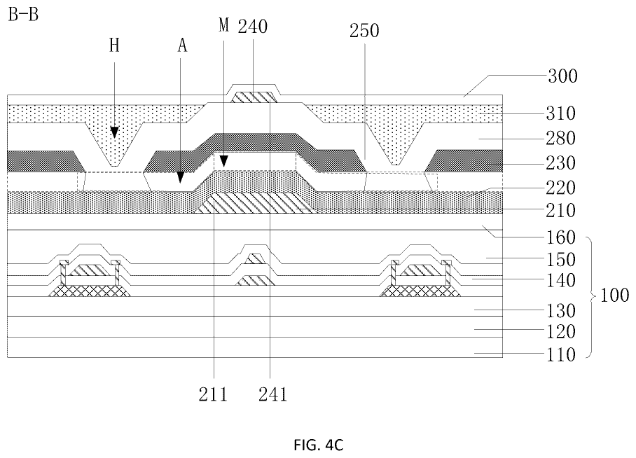

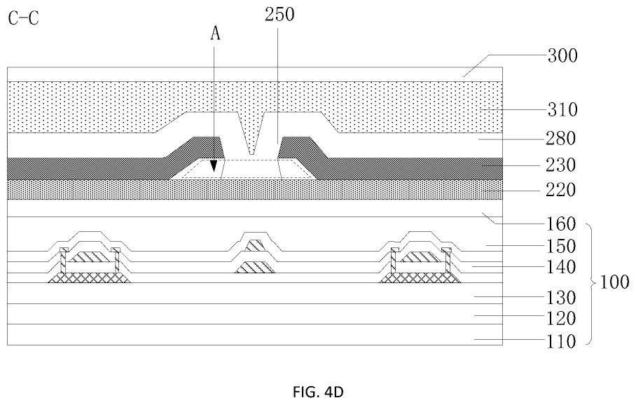

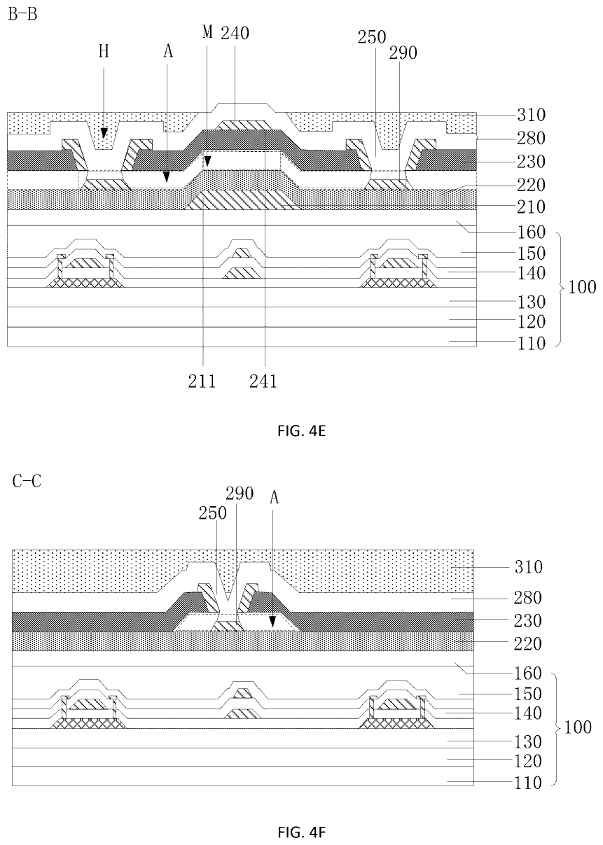

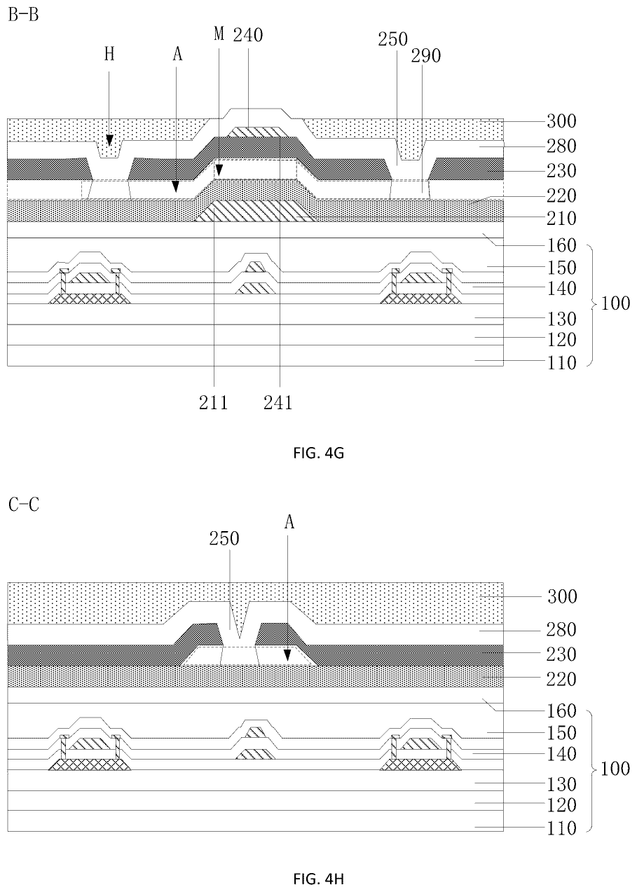

FIG. 4A is the sixth schematic diagram of the cross-sectional structure of the ultrasonic transducer provided by an embodiment of the present disclosure. FIG. 4B is the seventh schematic diagram of the cross-sectional structure of the ultrasonic transducer provided by an present embodiment. FIG. 4C is the eighth of the cross-sectional structure schematic diagram of the ultrasonic transducer provided by an embodiment of the present disclosure. FIG. 4D is the ninth schematic diagram of the cross-sectional structure of the ultrasonic transducer provided by an embodiment of the present disclosure. FIG. 4E is the tenth of the cross-sectional structure schematic diagram of the ultrasonic transducer provided by an embodiment of the present disclosure. FIG. 4F is the eleventh schematic diagram of the cross-sectional structure of the ultrasonic transducer provided by an embodiment of the present disclosure. FIG. 4G is the twelfth of the cross-sectional structure schematic diagram of the ultrasonic transducer provided by an embodiment of the present disclosure. FIG. 4H is the thirteenth of the schematic diagram of the cross-sectional structure of the ultrasonic transducer provided by an embodiment of the present disclosure.

In some embodiments, as shown in FIG. 4A to FIG. 4H, FIG. 4A, FIG. 4C, FIG. 4E and FIG. 4G are schematic diagrams of the cross-sectional structure of FIG. 1A along the cross-sectional line B-B, FIG. 4B, FIG. 4D, FIG. 4F and FIG. 4H are schematic diagrams of the cross-sectional structure of FIG. 1A along the cross-sectional line C-C, and the thickness of the second conductive layer 240 is less than the depth of the vibrating cavity M. Specifically, the depth of the vibrating cavity M can be set to 3000 Å, and the thickness of the second conductive layer 240 can be set to 2200 Å. The thickness of the second conductive layer 240 cannot meet the requirements of plugging the etching through hole H. The ultrasonic transducer also includes: the third inorganic layer 280. The third inorganic layer 280 is on a side away from the drive backboard 100, of the first inorganic layer 230, and the first inorganic filling portion 250 is in the third inorganic layer 280. The material of the third inorganic layer 280 can use inorganic materials such as silicon nitride, silicon nitride, silicon oxide, silicon oxide, etc., which is not limited here.

In some embodiments, as shown in FIG. 4A to FIG. 4D, the third inorganic layer 280 is between the second conductive layer 240 and the first inorganic layer 230. The third inorganic layer 280 can be prepared by thin film deposition process after etching the etching cavity pattern and the vibrating cavity pattern in the sacrificial layer S and before preparing the second conductive layer 240. In the specific embodiment, the thickness of the third inorganic layer 280 is greater than or equal to the depth of the etching cavity A, so that the first inorganic filling portion 250 can at least just plug the etching through hole H. When the thickness of the third inorganic layer 280 is equal to the depth of the etching cavity A, the inorganic material deposited in the etching cavity A can just plug the etching through hole H, and some inorganic materials are attached to the side wall of the etching through hole H, and the inorganic material attached to the side wall of the etching through hole H forms a continuous, uninterrupted layer with the inorganic material deposited in the etching cavity A, so as to form the first inorganic filling portion 250 and complete the preliminary encapsulation for the etching through hole. When the thickness of the third inorganic layer 280 is greater than the depth of the etching cavity A, more inorganic materials can be deposited in the etching through hole H to improve the encapsulation performance. After the inorganic material of the third inorganic layer 280 is deposited, the third inorganic layer 280 covers the first inorganic layer 230 and is filled in the etching cavity A and the etching through hole H.

In some embodiments, as shown in FIG. 4A and FIG. 4B, the thickness of the third inorganic layer 280 is less than the sum of the depth of the etching cavity A and the thickness of the first inorganic layer 230. The first inorganic filling portion 250 does not completely fill the etching through hole H and forms a pit. The second conductive layer 240 further includes a second inorganic filling portion 290. The inorganic filling portion 290 is in the pit to further improve the encapsulation performance for the etching through hole H. In the specific embodiment, after forming a third inorganic layer 280 covering the first inorganic layer 230 and filling in the etching cavity A and the etching through hole H, a second conductive layer 240 can be prepared on a side away from the drive backboard 100, of the third inorganic layer 280 through a thin film deposition process, and then the second conductive layer 240 is etched to form first electrodes 241 arranged at intervals and a second inorganic filling portion 290 located in the pit formed by the etching through hole H, which is not limited herein.

In some embodiments, as shown in FIG. 4C and FIG. 4D, the orthographic projection of the second conductive layer 240 on the drive backboard 100 does not overlap with the orthographic projection of etching through hole H on the drive backboard 100. In the specific embodiment, after forming a third inorganic layer 280 covering the first inorganic layer 230 and filling in the etching cavity A and the etching through hole H, a second conductive layer 240 can be prepared on a side away from the drive backboard 100, of the third inorganic layer 280 through a thin film deposition process, and then the second conductive layer 240 is etched to form a first electrode 241 and a second conductive layer 240 in a region overlapping with the etching through hole H is removed, so that the orthographic projection of the second conductive layer 240 on the drive backboard 100 and the orthographic projection of the etching through hole H on the drive backboard 100 do not overlap, so that the area of the second conductive layer 240 can be reduced, and parasitic capacitance between the second conductive layer 240 and the first conductive layer 210 in the unnecessary region or between the second conductive layer 240 and other conductive structures is avoided, and the risk of signal crosstalk is reduced.

In some embodiments, as shown in FIG. 4A to FIG. 4D, the ultrasonic transducer further includes a fourth inorganic layer 300. The fourth inorganic layer 300 is on a side away from the third inorganic layer 280, of the second conductive layer 240. The fourth inorganic layer 300 covers the second conductive layer 240 and the third inorganic layer 280 to further play the role of encapsulation and protection. The material of the fourth inorganic layer 300 can be inorganic materials such as silicon nitride, silicon nitride, silicon oxide, etc., which is not limited here. In the specific embodiment, the vibrating film of the ultrasonic transducer includes a first inorganic layer 230, a third inorganic layer 280 and a fourth inorganic layer 300 positioned above the vibrating cavity M. The thickness of the first inorganic layer 230 can be set to 1500 Å to 2500 Å, specifically can be set to 2000 Å, the thickness of the third inorganic layer 280 can be set to 2000 Å to 4000 Å, specifically can be set to 3000 Å, and the thickness of the fourth inorganic layer can be set to 500 Å to 1500 Å, Specifically, it can be set to 1000 Å, and the thicker the thickness of the fourth inorganic layer 300 is, the more the protection effect of the second conductive layer 240 can be improved. The total thickness of the first inorganic layer 230, the third inorganic layer 280 and the fourth inorganic layer 300 is less than or equal to 6000 Å to avoid the increase in power consumption of the ultrasonic transducer due to excessive thickness of the vibrating film, and to ensure the sensitivity of the ultrasonic transducer. The embodiments shown in FIG. 4C and FIG. 4D, compared with the embodiments shown in FIG. 4A and FIG. 4B, do not use the conductive material of the second conductive layer 240 to encapsulate the etching through hole H, and the thicknesses of the first inorganic layer 230, the third inorganic layer 280 and the fourth inorganic layer 300 are 2000 Å, 3000 Å and 1000 Å, respectively, The parasitic capacitance of the ultrasonic transducer is about 12.5 fc in the embodiments shown in FIG. 4C and FIG. 4D, and the parasitic capacitance of the ultrasonic transducer in the embodiments shown in FIG. 4A and FIG. 4B is about 13.9 fc, and the area reduction of the second conductive layer 240 can significantly reduce the parasitic capacitance in the ultrasonic transducer.

In some embodiments, as shown in FIG. 4E to FIG. 4H, the third inorganic layer 280 is on a side away from the first inorganic layer 230, of the second conductive layer 240. In specific embodiment, the third inorganic layer 280 covers the second conductive layer 240 to protect the second conductive layer 240, so that the number of encapsulation layers arranged directly above the vibrating cavity M can be reduced, and the thickness of the vibrating is reduced, thereby the driving voltage is reduced, and the power consumption of the ultrasonic transducer is reduced.

In some embodiments, as shown in FIG. 4E and FIG. 4F, the second conductive layer 240 further includes a second inorganic filling portion 290. The second inorganic filling portion 290 is in the etching cavity A. The first inorganic filling portion 250 is on a side away from the drive backboard 100, of the second inorganic filling portion 290. The thickness of the third inorganic layer 280 is greater than or equal to the difference between the depth of the vibrating cavity M and the thickness of the second conductive layer 240, so that the first inorganic filling portion 250 can at least just plug the etching through hole H. In the specific implementation, after the etching cavity pattern and the vibrating cavity pattern of the sacrificial layer are completely etched away, a second conductive layer 240 can be formed on a side away from the drive backboard 100, of the first inorganic layer 230 through a thin film deposition process. A part of the second conductive layer 240 is deposited in the etching cavity A through the etching through hole H to form a second inorganic filling portion 290. Because the thickness of the second conductive layer 240 is less than the depth of the etching cavity A, the second inorganic filling portion 290 cannot effectively plug the etching through hole H, and then a third inorganic layer 280 is formed on a side away from the drive backboard 100, of the second conductive layer 240 through a thin film deposition process. A part of the third inorganic layer 280 is deposited in the etching cavity A through the etching through hole H, and forms on a side away from the drive backboard 100, of the second inorganic filling portion 290 to form a first inorganic filling portion 250. Specifically, the thickness of the third inorganic layer 280 is greater than or equal to the difference between the depth of the vibrating cavity M and the thickness of the second conductive layer 240, so that the first inorganic filling part 250 can effectively plug the etching through hole H and play the role of preliminary encapsulation. By forming a second inorganic filling portion 290 in etching cavity A, when preparing a first inorganic filling portion 250, the thickness of the third inorganic layer 280 can be thinned, and then the thickness of the vibrating film can be reduced, the driving voltage of the ultrasonic transducer can be reduced, and the power consumption can be reduced.

In some embodiments, as shown in FIG. 4G and FIG. 4H, the orthographic projection of the second conductive layer 240 on the drive backboard 100 does not overlap with the orthographic projection of the etching through hole H on the drive backboard. The thickness of the third inorganic layer 230 is greater than or equal to the depth of the etching cavity A, so that the second inorganic filling portion 290 can be not arranged, and the etching through hole H can be directly plugged through the first inorganic filling portion 250 formed by the third inorganic layer 280. In the specific implementation, after the etching cavity pattern and the vibrating cavity pattern of the sacrificial layer are completely etched away, a second conductive layer 240 can be formed on a side away from the drive backboard 100, of the first inorganic layer 230 through a thin film deposition process, and the material of the second conductive layer 240 deposited in the etching cavity A is etched off through an etching through hole H, and then a third inorganic layer 280 is formed on a side away from the drive backboard 100, of the second conductive layer 240 through a thin-film deposition process. A part of the third inorganic layer 280 is deposited in the etching cavity A and filled in the etching through hole H by the etching hole H to form the first inorganic filling portion 250 to plug the etching through hole H.

In the embodiment shown in FIG. 4E to FIG. 4H, the vibrating film of the ultrasonic transducer includes a first inorganic layer 230 and a third inorganic layer 280 positioned above the vibrating cavity M. The thickness of the first inorganic layer 230 can be set to 1000 Å to 2500 Å, specifically can be set to 2000 Å, the thickness of the third inorganic layer 280 can be set to 3000 Å to 5000 Å, specifically can be set to 4000 Å, and the thicker the thickness of the third inorganic layer 280 is, the more the protection effect for the second conductive layer 240 can be improved. The total thickness of the first inorganic layer 230 and the third inorganic layer 280 is less than or equal to 6000 Å to avoid the increase in power consumption of the ultrasonic transducer due to excessive thickness of the vibrating film, and to ensure the sensitivity of the ultrasonic transducer. As shown in FIG. 4E to FIG. 4H, the number of layers directly above the vibrating cavity M is smaller, which is conducive to reducing the thickness of the vibrating film, thereby reducing the driving voltage and reducing the power consumption of the ultrasonic transducer. The embodiments shown in FIG. 4G and FIG. 4H, compared with the embodiments shown in FIG. 4E and FIG. 4F, the second inorganic filling portion 290 is not arranged in the etching cavity A, the area of the second conductive layer 240 in the embodiments shown in FIG. 4G and FIG. 4H is smaller, and the thickness of the first inorganic layer 230 and the third inorganic layer 280 is 2000 Å and 4000 Å respectively, The parasitic capacitance in the embodiments shown in FIG. 4G and FIG. 4H is about 12.5 fc, and the parasitic capacitance in the embodiments shown in FIG. 4E and FIG. 4F is about 13.9 fc, and the area reduction of the second conductive layer 240 can significantly reduce the parasitic capacitance in the ultrasonic transducer.

In some embodiments, as shown in FIG. 4A to FIG. 4H, the ultrasonic transducer further includes a second planarization layer 310. The second planarization layer 310 is on a side away from the drive backboard 100, of the third inorganic layer 280, which can further improve the encapsulation performance for the etching through hole H. The second planarization layer 310 is also used for forming a relatively flat surface, which is convenient for the manufacture of the subsequent film layer, and the relatively flat surface is conducive to improving the directionality of emitting ultrasonic waves and the sensitivity of receiving ultrasonic waves.

In the specific implementation, as shown in FIG. 4a to FIG. 4H, the height of the third inorganic layer 280 in the region overlapping with the vibrating cavity M is greater than the height of other regions of the third inorganic layer 280. The height of the second planarization layer 310 is less than or equal to the height of the third inorganic layer 280 in the region overlapping with the vibrating cavity M, so as to expose the surface of the third inorganic layer 280 in the region overlapping with the vibrating cavity M, so that the second planarization layer 310 can be avoided from increasing the thickness of the vibrating film located above the vibrating cavity M, reducing the driving voltage, thereby reducing the power consumption of the ultrasonic transducer.

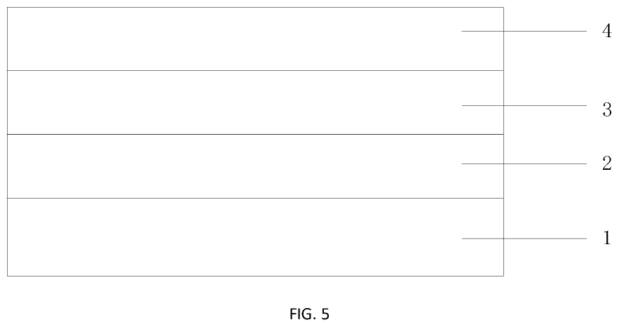

FIG. 5 is a schematic diagram of the cross-sectional structure of the display panel provided by an embodiment of the present disclosure.

The second aspect of the present disclosure further provides a display panel including the ultrasonic transducer provided in any of the above embodiments. In the specific implementation, the display panel can be a liquid crystal display (LCD) panel, an organic light emitting diode (OLED) display panel, a light emitting diode (LED) display panel, a micro light emitting diode (Micro LED) display panels, etc., are not limited herein. The ultrasonic transducer can be used for realizing the fingerprint recognition, gesture recognition, touch operation and other functions of the display panel, which is not limited here.

For example, the display panel provided in the present disclosure may be an OLED display panel, as shown in FIG. 5, and the OLED display panel may include an ultrasonic transducer 1, a matching layer 2, an OLED display substrate 3 and a protective cover plate 4 arranged in succession. The matching layer 2 is used for impedance matching between the ultrasonic transducer 1 and the OLED display substrate 3, improving the ultrasonic transmission efficiency, and carrying out the bonding between the ultrasonic transducer 1 and the OLED display substrate 3. In the specific implementation, the matching layer 2 can be optically clear adhesive (OCA), which is not limited here. In the specific implementation, the OLED display panel can also be for other structures without limitation. When the display panel provided in this disclosure is another type of display panel, the structure is similar to that of the OLED display panel, and will not be repeated here.

The display panel provided in the embodiment of the present disclosure has the same or similar technical effect as the ultrasonic transducer provided in any of the above embodiments, and will not be repeated herein.

The third aspect of the disclosure further provides a display device, which includes a display panel provided by any of the above embodiments. The display device can be a mobile phone, tablet, laptop, etc., and is not limited here. The display device provided in the embodiment of the present disclosure has the same or similar technical effect as the display panel provided in any of the above embodiments, and is not repeated herein.

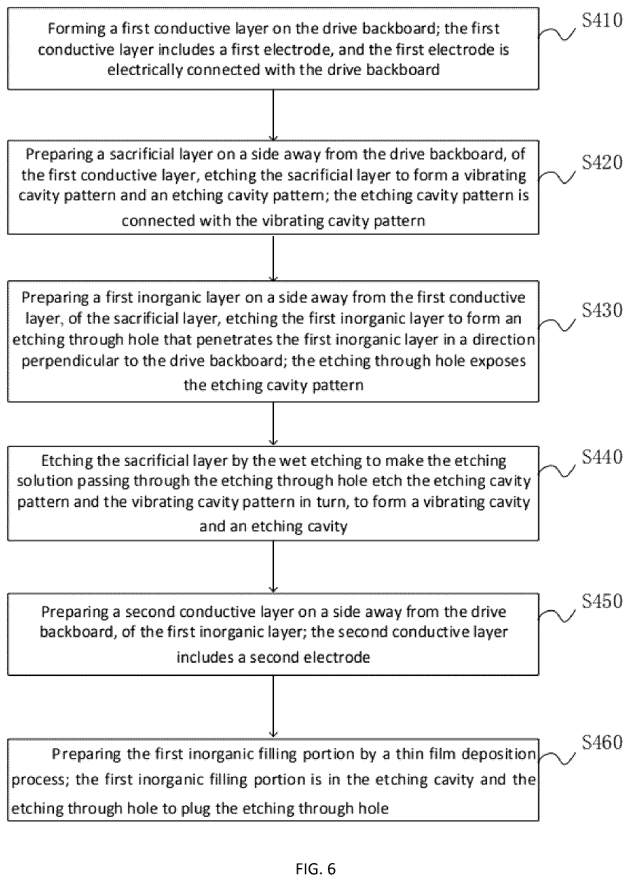

FIG. 6 is a flow chart of the manufacturing method of the ultrasonic transducer provided by an embodiment of the present disclosure.

The fourth aspect of the present disclosure further provides a method for manufacturing an ultrasonic transducer, as shown in FIG. 6, which includes the following steps:
S410: forming a first conductive layer on the drive backboard; the first conductive layer includes a first electrode, and the first electrode is electrically connected with the drive backboard;
S420: preparing a sacrificial layer on a side away from the drive backboard, of the first conductive layer, etching the sacrificial layer to form a vibrating cavity pattern and an etching cavity pattern; the etching cavity pattern is connected with the vibrating cavity pattern;
S430: preparing a first inorganic layer on a side away from the first conductive layer, of the sacrificial layer, etching the first inorganic layer to form an etching through hole that penetrates the first inorganic layer in a direction perpendicular to the drive backboard; the etching through hole exposes the etching cavity pattern;
S440: etching the sacrificial layer by the wet etching to make the etching solution passing through the etching through hole etch the etching cavity pattern and the vibrating cavity pattern in turn, to form a vibrating cavity and an etching cavity;
S450: preparing a second conductive layer on a side away from the drive backboard, of the first inorganic layer; the second conductive layer includes a second electrode;
S460: preparing the first inorganic filling portion by a thin film deposition process; the first inorganic filling portion is in the etching cavity and the etching through hole to plug the etching through hole.

The manufacturing method of the ultrasonic transducer provided by an embodiment of the present disclosure is that after forming a vibrating cavity M and an etching cavity A by etching the sacrificial layer S through wet etching, the etching through hole H is encapsulated through a thin film deposition process, and the inorganic material no longer flows after attaching to the substrate surface, and the film-forming process has good directionality, and can avoid the inorganic material diffusing into the vibrating cavity M along the extension direction of the etching cavity A and causing blockage to the vibrating cavity M. The organic materials have a certain fluidity. When the organic materials are used for encapsulating the etching through hole H, the organic materials flow into the vibrating cavity M along the extension direction of the etching cavity A, which is easy to cause the blockage of the vibrating cavity M, and the product yield can be greatly improved by encapsulating the etching through hole H with inorganic materials compared with encapsulating the etching through hole H with the organic materials.

In addition, as shown in FIG. 1D, in the ultrasonic transducer provided by an embodiment of the present disclosure, the etching through hole H is directly prepared on the first inorganic layer 230, and when the etching through hole H is encapsulated, the etching through hole H and the etching cavity A directly opposite below the etching through hole H are completely filled in the direction perpendicular to the drive backboard 100, and the thickness of the encapsulation layer to be deposited is only the sum of the depth of the etching cavity A and the thickness of the first inorganic layer 230. Taking the depth of the etching cavity A is 3000 Å, the thickness of the first inorganic layer 230 is 2000 Å as an example, the etching cavity A directly opposite the etching through hole H and the etching through hole H are completely filled, only a film layer with a thickness of 5000 Å needs to be deposited, and the thickness of the required encapsulation layer is small, which is conducive to reducing the difficulty of preparing the encapsulation layer.

The embodiment of the present disclosure has described the specific structure of the ultrasonic transducer in detail, and the specific manufacturing method of the ultrasonic transducer provided in the embodiment of the present disclosure may refer to the specific structure of the aforementioned ultrasonic transducer, and will not be repeated here.

Although preferred embodiments of the present disclosure have been described, those embodiments may make additional changes and modifications to these embodiments once they have knowledge of the basic concept of inventive step. Therefore, the attached claims are intended to be construed to include the preferred embodiments and all changes and modifications that fall within the scope of this disclosure.

Obviously, a person skilled in the art may make various alterations and variations to the present disclosure without departing from the spirit and scope of the present disclosure. Thus, to the extent that such modifications and variants of the present disclosure fall within the scope of the claims of the present disclosure and its equivalents, the present disclosure is also intended to include such modifications and variants.

1. An ultrasonic transducer, comprising:
a drive backboard;
a first conductive layer, located on the drive backboard and comprising a first electrode, the first electrode being electrically connected with the drive backboard;
a first inorganic layer on a side of the first conductive layer facing away from the drive backboard; wherein a vibrating cavity and an etching cavity are provided between the first inorganic layer and the first conductive layer; the first inorganic layer is provided with an etching through hole penetrating the first inorganic layer in a direction perpendicular to the drive backboard; the etching cavity is connected with the vibrating cavity and the etching through hole respectively to form an etching channel;
a second conductive layer on a side of the first inorganic layer facing away from the drive backboard, the second conductive layer comprising a second electrode;
a first inorganic filling portion in the etching cavity and the etching through hole to plug the etching through hole; wherein a material of the first inorganic filling portion is an inorganic material.

2. The ultrasonic transducer of claim 1, wherein,
a thickness of the second conductive layer is greater than or equal to a depth of the etching cavity;
the first inorganic filling portion is in the second conductive layer.

3. The ultrasonic transducer of claim 2, further comprising:
a first planarization layer on a side of the second conductive layer facing away from the drive backboard; wherein an orthographic projection of the first planarization layer on the drive backboard does not overlap with an orthographic projection of the vibrating cavity on the drive backboard;
a second inorganic layer on a side of the first planarization layer facing away from the drive backboard, the second inorganic layer covering the first planarization layer and the second conductive layer.

4. The ultrasonic transducer of claim 3, wherein,
a height of the first inorganic layer in a region overlapping with the vibrating cavity is greater than a height of the first inorganic layer in other regions;
a height of the first planarization layer is less than or equal to the height of the first inorganic layer in the region overlapping with the vibration cavity, so as to expose a surface of the first inorganic layer in the region overlapping with the vibrating cavity.

5. The ultrasonic transducer of claim 1, wherein,
a thickness of the second conductive layer is less than a depth of the vibrating cavity;
the ultrasonic transducer further comprises:
a third inorganic layer on a side of the first inorganic layer facing away from the drive backboard; the first inorganic filling portion is in the third inorganic layer.

6. The ultrasonic transducer of claim 5, wherein,
the third inorganic layer is between the second conductive layer and the first inorganic layer;
a thickness of the third inorganic layer is greater than or equal to a depth of the etching cavity.

7. The ultrasonic transducer of claim 6, wherein,
the thickness of the third inorganic layer is less than a sum of the depth of the etching cavity and a thickness of the first inorganic layer;
the etching through hole is not completely filled with the first inorganic filling portion so as to form a pit;
the second conductive layer further comprises a second inorganic filling portion; the second filling portion is in the pit.

8. The ultrasonic transducer of claim 6, wherein an orthotropic projection of the second conductive layer on the drive backboard does not overlap with an orthotropic projection of the etching through hole on the drive backboard.

9. The ultrasonic transducer of claim 6, further comprising:
a fourth inorganic layer on a side of the second conductive layer facing away from the third inorganic layer, the fourth inorganic layer covering the second conductive layer.

10. The ultrasonic transducer of claim 5, wherein the third inorganic layer is on a side of the second conductive layer facing away from the first inorganic layer and covers the second conductive layer.

11. The ultrasonic transducer of claim 10, wherein,
the second conductive layer further comprises a second inorganic filling portion; the second inorganic filling portion is in the etching cavity;
the first inorganic filling portion is on a side of the second inorganic filling portion facing away from the drive backboard;
a thickness of the third inorganic layer is greater than or equal to a difference between the depth of the vibrating cavity and the thickness of the second conductive layer.

12. The ultrasonic transducer of claim 10, wherein,
an orthographic projection of the second conductive layer on the drive backboard does not overlap with an orthographic projection of the etching through hole on the drive backboard;
a thickness of the third inorganic layer is greater than or equal to a depth of the etching cavity.

13. The ultrasonic transducer of claim 5, further comprising:
a second planarization layer on a side of the third inorganic layer facing away from the drive backboard;
a height of the third inorganic layer in a region overlapping with the vibrating cavity is greater than a height of the third inorganic layer in other regions;
a height of the second planarization layer is less than or equal to the height of the third inorganic layer in the region overlapping with the vibrating cavity, so as to expose a surface of the third inorganic layer in the region overlapping with the vibrating cavity.

14. The ultrasonic transducer of claim 1, further comprising:
a buffer layer between the first conductive layer and the first inorganic layer; the vibrating cavity and the etching cavity are between the first inorganic layer and the buffer layer.

15. A display panel, comprising the ultrasonic transducer of claim 1.

16. A display device, comprising the display panel of claim 15.

17. A manufacturing method for an ultrasonic transducer, comprising:
forming a first conductive layer on a side of a drive backboard; wherein the first conductive layer comprises a first electrode, and the first electrode is electrically connected with the drive backboard;
preparing a sacrificial layer on a side of the first conductive layer facing away from the drive backboard;
etching the sacrificial layer to form a vibrating cavity pattern and an etching cavity pattern; the etching cavity pattern being connected with the vibrating cavity pattern;
preparing a first inorganic layer on a side of the sacrificial layer facing away from the first conductive layer;
etching the first inorganic layer to form an etching through hole that penetrates the first inorganic layer in a direction perpendicular to the drive backboard; wherein the etching through hole exposes the etching cavity pattern;
etching the sacrificial layer by a wet etching, so that an etching solution etches the etching cavity pattern and the vibrating cavity pattern successively through the etching through hole to form a vibrating cavity and an etching cavity;
preparing a second conductive layer on a side of the first inorganic layer facing away from the drive backboard; wherein the second conductive layer comprises a second electrode;
preparing a first inorganic filling portion in a thin film deposition process; wherein the first inorganic filling portion is in the etching cavity and the etching through hole to plug the etching through hole.
